(19) United States
(12) Patent Application Publication
(10) Pub. No.: US 2026/0139828 A1
(43) Pub. Date: May 21, 2026

(54) SUPERHEATED STEAM GENERATOR

(71) Applicant: TOKUDEN CO., LTD., Kyoto-shi (JP)

(72) Inventor: Toru TONOMURA, Otsu-shi (JP)

(21) Appl. No.: 19/391,803

(22) Filed: Nov. 17, 2025

(30) Foreign Application Priority Data
Nov. 20, 2024 (JP) 2024-202741
Feb. 17, 2025 (JP) 2025-023510

(51) Int. Cl. F22G 1/16; F22G 3/00

(52) U.S. Cl. CPC F22G 1/165; F22G 3/002; F22G 3/008

(57) ABSTRACT

A superheated steam generator that controls the amount of generated steam, on the basis of the amount of electric power, includes: a steam generation unit that generates steam by inductively heating a spiral-shaped first conductor pipe; a superheated steam generation unit that generates superheated steam by inductively heating a spiral-shaped second conductor pipe; a control unit that controls an amount of generated steam based on an amount of supplied electric power; and a safety device that prevents damage to the steam generation units, based on a pressure or a temperature of the steam, in which the first conductor pipe has a first winding portion that is a spiral winding; the second conductor pipe has a second winding portion that is a spiral winding; and the safety device is provided to the first winding portion, or to a communication pipe part connecting the first and second winding portions.

### CROSS-REFERENCE TO RELATED APPLICATION(S)

The present application claims priority to Japanese Patent Application No. 2024-202741 filed Nov. 20, 2024, and Japanese Patent Application No. 2025-023510 filed Feb. 17, 2025, both of which are incorporated herein by reference in their entireties.

### BACKGROUND OF THE INVENTION

### Technical Field

The present invention relates to a superheated steam generator.

### Description of the Related Art

Having been developed as a conventional superheated steam generator, as disclosed in JP 2019-113282 A, is a superheated steam generator including an induction-heating steam generation unit that generates steam by heating water, and an induction-heating superheated steam generation unit that generates superheated steam by heating steam, and configured to control the amount of steam generated by the steam generation unit on the basis of the amount of electric power supplied to the steam generation unit (power-controlled superheated steam generator).

### PRIOR ART DOCUMENT

### Patent Document

JP 2019-113282 A

### SUMMARY OF THE INVENTION

In such a power-controlled superheated steam generator, because the thermal energy per unit weight of water required for the water to turn into steam under a predetermined pressure is constant, as a physical constant, by converting the calorie required for the amount of steam to be generated into the electric power, and by supplying the electric power, it is possible to achieve high controllability in the amount of steam to be generated.

In the power-controlled generator, however, although the stable amount of steam is generated by inputting the electric power required for generating an intended amount of steam, the pressure at which the steam is discharged is adjusted naturally in accordance with the amount of steam thus generated. In other words, the discharge pressure rises when the load loss in the steam channel increases, and in the worst case, the discharge pressure rises to a level where the generator breaks.

With the foregoing in view, the present invention has been made to address the problem described above, and a main object of the present invention is to prevent damage to a steam generation unit or a superheated steam generation unit in a superheated steam generator in which the amount of generated steam is controlled on the basis of the amount of electric power.

In other words, a superheated steam generator according to the present invention is a superheated steam generator including: a steam generation unit that generates steam from water by inductively heating a first conductor pipe having a spiral shape; a superheated steam generation unit that generates superheated steam from the steam by inductively heating a second conductor pipe having a spiral shape; a control unit that controls an amount of steam to be generated by the steam generation unit based on an amount of electric power to be supplied to the steam generation unit; and a safety device that prevents damage to the steam generation unit or the superheated steam generation unit, based on a pressure or a temperature of the steam in the steam generation unit, in which the first conductor pipe has a first winding portion that is a spiral winding; the second conductor pipe has a second winding portion that is a spiral winding; and the safety device is provided to the first winding portion, or to a communication pipe part communicably connecting the first winding portion and the second winding portion.

In the power-controlled superheated steam generator, for example, when the evaporation temperature rises from 120° C. to 130° C. by 10° C., the pressure increases from about 0.199 MPa to about 0.27 MPa, corresponding to an increase by about 1.36 times, but an increase in the required enthalpy remains only 1.0055 times, that is, from 2706 KJ/kg to 2721 KJ/kg. Although applications in which the pressure rises by 36% are very unlikely, even under such an assumption, a variation in the amount of generated steam remains within the range of 0.55%. Furthermore, when the evaporation temperature rises from 120° C. to 175° C. by 55° C., the pressure increases from about 0.199 MPa to 0.892 MPa, which corresponds to an increase of about 4.49 times. However, an increase in the required enthalpy remains only 1.0251 times, that is, from 2706 KJ/kg to 2774 KJ/kg, and a variation in the amount of generated steam remains within a range of 2.51%. In the superheated steam generator according to the present invention, the stability of the amount of generated steam is set within ±1%, for example, and the safety device can be activated at a pressure of 0.35 MPa (at an enthalpy of about 2730 KJ/kg), for example. Under the pressure of 0.35 MPa, the enthalpy increases about 2.0% from that at 99.63° C. (an enthalpy of about 2675 KJ/kg at the pressure of 0.1 MPa), and the variation in the amount of steam can be kept within ±1%.

| Temperature | Pressure | Ratio of | Enthalpy | Ratio of |
|---|---|---|---|---|
| (° C.) | (MPa) | Pressures | (kJ/kg) | Enthalpies |
| 120 | 0.1985 | — | 2706 | — |
| 130 | 0.2701 | 1.36 | 2721 | 1.0055 |
| 175 | 0.8920 | 4.49 | 2774 | 1.0251 |

According to the present invention, the safety device can prevent damage to the steam generation unit or the superheated steam generation unit even in case of an increase of the discharge pressure (a discharge temperature corresponding to the discharge pressure), as a result of an increase in the load loss in the steam channel such as the first conductor pipe. Furthermore, in the present invention, even if the strength of the conductor pipe drops as a result of a temperature increase, the safety device can prevent damage to the conductor pipe.

In particular, in the present invention, because the safety device is provided to the first winding portion of the first conductor pipe or the communication pipe part communicably connecting the first winding portion of the first conductor pipe and the second winding portion of the second conductor pipe, it is possible to detect a rise in the pressure or the temperature of the steam in the steam generation unit directly, and to prevent damage to the steam generation unit or the superheated steam generation unit. The communication pipe part herein at least includes a first lead-out portion having a first outlet port through which the steam in the first conductor pipe is guided out, and a second lead-in portion having a second inlet port through which the steam in the second conductor pipe is introduced.

As a specific embodiment of the safety device, preferably, the safety device includes a releasing unit that is provided to the first winding portion or to the communication pipe part communicably connecting the first winding portion and the second winding portion, and that releases the steam to outside.

As another specific embodiment of the safety device, preferably, the safety device includes: a pressure sensor that is provided to the first winding portion or to the communication pipe part communicably connecting the first winding portion and the second winding portion, and that detects a pressure of the steam; and a safety circuit that outputs an alert signal based on a detected pressure from the pressure sensor.

Specifically, the safety circuit may be configured to compare the detected pressure from the pressure sensor with a boundary-point pressure at which a target range of variation in the amount of generated steam is exceeded, and to output the alert signal when the detected pressure reaches the boundary-point pressure.

In this configuration, an enthalpy value that can be calculated from the temperature of saturated steam is converted into an amount of steam generated, and an alert is issued at the boundary-point pressure at which the target range of variation in the amount of generated steam is exceeded. Because power-controlled superheated steam generators are not provided with a pressure-reduction valve, a regulation valve for adjusting the amount of steam, and an electric proportional valve, the steam pressure is kept low, so that the saturated steam pressure of 0.1 MPa, the saturated steam temperature of 99.63° C., and the enthalpy of 2675 KJ/kg can be considered as the minimum values. For example, assuming that the target range of variation in the amount of generated steam is set as ±1.5%, the enthalpy is calculated as 2675×1.03=2755 KJ/kg. The saturated steam pressure corresponding to this enthalpy is then 0.6 MPa, and the saturated steam temperature corresponding thereto is 158.84° C. In such a case, the boundary-point pressure is set to 0.6 MPa, as an example. In other words, by inputting electric power that is a conversion of an enthalpy of 2715 KJ/kg for generating steam, even when the discharge pressure reaches 0.6 MPa as a result of an increased load loss in the pressure, the decrease in the amount of generated steam remains about 1.47%, on the basis of (2755/2715)−1≈0.0147. By contrast, when the load pressure loss is low and the discharge pressure is 0.1 MPa, the increase in the amount of generated steam is about 1.47%, on the basis of 1−(2675/2715)≈0.0147. Therefore, the amount of steam being generated exhibits a variation within the range of about ±1.5%. Note that the electric power to be actually input will be a value taking the device efficiency such as the thermal energy for increasing the water temperature and the heat dissipation into consideration, and the calculation described above is a calculation only of the steam to be generated.

As another specific embodiment of the safety device, preferably, the safety device includes: a temperature sensor that is provided to the first winding portion or the communication pipe part communicably connecting the first winding portion and the second winding portion, and that detects a temperature of the steam; and a safety circuit that outputs an alert signal based on a detected temperature from the temperature sensor.

Specifically, the safety circuit preferably includes a safety circuit configured to compare the detected temperature from the temperature sensor with a boundary-point temperature at which the target range of variation in the amount of generated steam is exceeded, and to output the alert signal when the detected temperature reaches the boundary-point temperature.

In this configuration, an enthalpy value that can be calculated from the temperature of saturated steam is converted into an amount of steam generated, and an alert is issued at the boundary-point temperature at which the target range of variation in the amount of generated steam is exceeded. When the target range of variation in the amount of generated steam is set to ±1.5% as described above, the boundary-point temperature is set to 158.84° C., for example.

As another specific embodiment of the safety device, preferably, the safety device includes: a pressure sensor that is provided to the first winding portion or to the communication pipe part communicably connecting the first winding portion and the second winding portion, and that detects a pressure of the steam; a temperature sensor that is provided to the first winding portion or to the communication pipe part communicably connecting the first winding portion and the second winding portion, and that detects a temperature of the steam; and a safety circuit that outputs an alert signal based on a detected pressure from the pressure sensor and a detected temperature from the temperature sensor.

Preferably, the safety circuit outputs a caution signal before outputting the alert signal.

In this configuration, because the caution signal is output before the alert signal is output, the user is encouraged to inspect a user-side facility in which the superheated steam generator 100 is incorporated.

The safety device may be further provided to the second winding portion or to the second lead-out portion having a second outlet port through which the superheated steam is guided out, and prevent damage to the steam generation unit or the superheated steam generation unit based on a pressure or a temperature of the superheated steam.

With this configuration, it is possible to detect a rise in the pressure or the temperature of the steam generation unit indirectly, by means of the pressure or the temperature of the superheated steam in the superheated steam generation unit, and to prevent damage to the steam generation unit or the superheated steam generation unit.

According to the present invention configured as described above, it is possible to prevent damage to the steam generation unit or the superheated steam generation unit in a superheated steam generator in which the amount of generated steam is controlled on the basis of the amount of electric power.

### BRIEF DESCRIPTION OF THE DRAWINGS

FIG. 1 is a diagram schematically illustrating a configuration of a superheated steam generator according to a first embodiment;

FIG. 2 is a diagram illustrating an example of a hollow conductor pipe according to the embodiment;

FIG. 3 is a diagram mainly illustrating a structure of an iron core in each steam generation unit according to the embodiment;

FIG. 4 is a diagram illustrating a modification of the structure of the iron core in each of the steam generation units according to the embodiment;

FIG. 5 is a diagram illustrating a connection between induction coils in the respective steam generation units according to the embodiment;

FIG. 6 is a diagram schematically illustrating a configuration of a control device according to the embodiment;

FIG. 7 is a diagram schematically illustrating a configuration of a superheated steam generator according to a second embodiment;

FIG. 8 is a graph indicating an operation of the superheated steam generator according to the embodiment;

FIG. 9 is a diagram schematically illustrating a configuration of a superheated steam generator according to a modification; and

FIG. 10 is a diagram schematically illustrating a configuration of a superheated steam generator according to another modification.

### DETAILED DESCRIPTION

### First Embodiment

A first embodiment of a superheated steam generator according to the present invention will now be explained with reference to some drawings.

The superheated steam generator 100 according to the embodiment generates superheated steam having a temperature higher than 100° C. (200° C. to 2000° C.), by heating water.

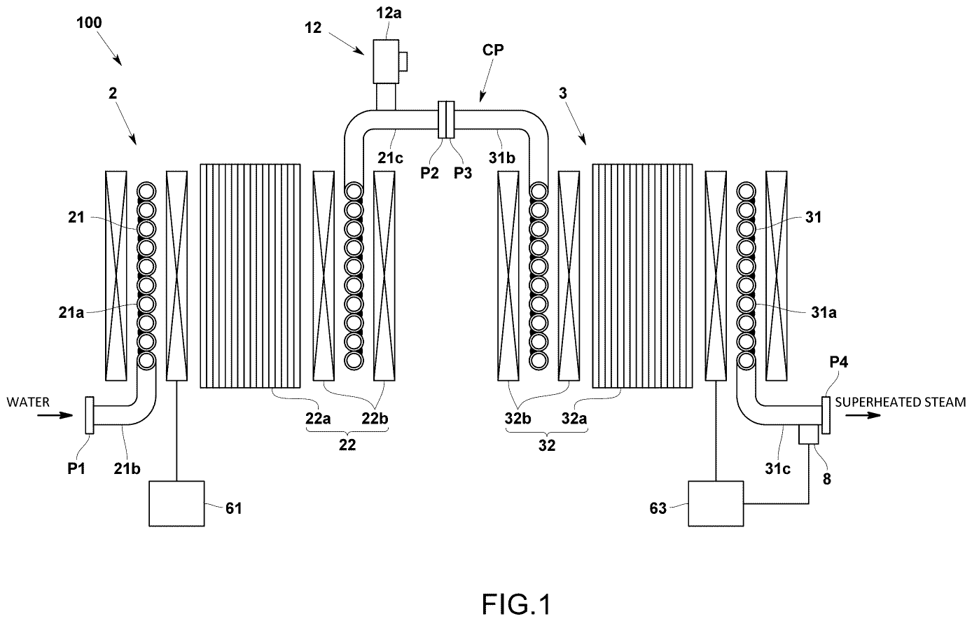

Specifically, as illustrated in FIG. 1, the superheated steam generator 100 includes a steam generation unit 2 that generates saturated steam by heating water (hereinafter, referred to as a saturated steam generation unit 2), and a superheated steam generation unit 3 that generates superheated steam by heating the saturated steam. In FIG. 1, a power supply circuit is not illustrated.

### <Configuration of Saturated Steam Generation Unit 2>

The saturated steam generation unit 2 is an induction-heating saturated steam generation unit, and includes a first conductor pipe 21 that is a spiral winding of a circular pipe, and a magnetic flux generation mechanism 22 for inductively heating the first conductor pipe 21.

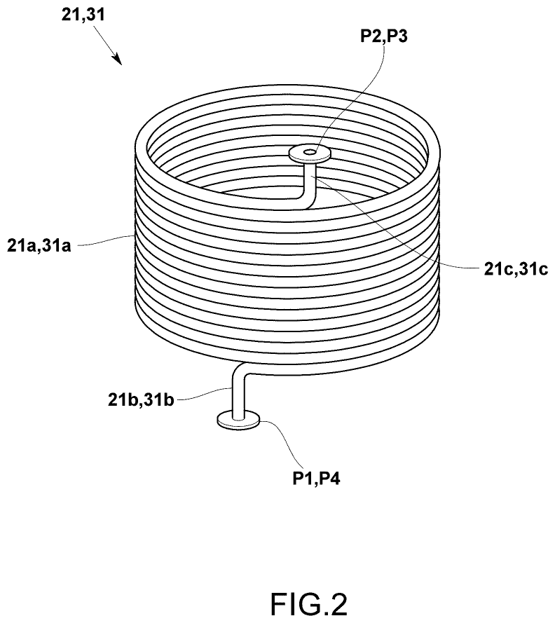

As illustrated in FIG. 2, the first conductor pipe 21 includes a first winding portion 21a that is a spirally wound portion formed of one metal pipe, and has one end provided with a first inlet port P1 through which water is introduced, and the other end provided with a first outlet port P2 through which the generated saturated steam is guided out. The first winding portion 21a includes a first lead-in portion 21b extending outward from the one end of the first winding portion 21a, and being where the first inlet port P1 is provided. The first winding portion 21a also has a first lead-out portion 21c extending outward from the other end of the first winding portion 21a, and being where the first outlet port P2 is provided. The first conductor pipe 21 serves as a container in which saturated steam is generated. For the first conductor pipe 21, austenitic stainless steel, such as SUS 304, or an alloy, such as Inconel, having high heat resistance and mechanical strength may be used. Mutually adjacent wound portions of the first conductor pipe 21 are electrically connected to each other by welding, for example.

The magnetic flux generation mechanism 22 includes an iron core 22a and an induction coil 22b wound about the iron core 22a. An AC power supply is connected to the induction coil 22b, and controlled electric power is supplied thereto. The frequency of the AC power supply is 50 Hz or 60 Hz that is a commercial frequency. The electric power supplied from the AC power supply causes the induction coil 22b to serve as a primary coil, and, as a result of the first conductor pipe 21 receiving the supply of power from the primary coil, induction current flows through the first conductor pipe 21, and causes the first conductor pipe 21 to serve as a single-turn secondary coil. The first conductor pipe 21 generates Joule heat, by which the water in the first conductor pipe 21 is heated, and saturated steam is generated. The first conductor pipe 21 is filled with water up to a predetermined level.

### <Configuration of Superheated Steam Generation Unit 3>

The superheated steam generation unit 3 is an induction-heating superheated steam generation unit, and includes a second conductor pipe 31 that is a spiral winding of a circular pipe, and a magnetic flux generation mechanism 32 for inductively heating the second conductor pipe 31.

As illustrated in FIG. 2, the second conductor pipe 31 includes a second winding portion 31a that is a spirally wound portion formed of one metal pipe, and has one end provided with a second inlet port P3 through which the steam from the saturated steam generation unit 2 is introduced, and the other end provided with a second outlet port P4 through which the superheated steam generated therein is guided out. The second winding portion 31a includes a second lead-in portion 31b extending outward from the one end of the second winding portion 31a, and being where second inlet port P3 is provided. The second winding portion 31a has a second lead-out portion 31c extending outward from the other end of the second winding portion 31a, and being where the second outlet port P4 is provided. The second conductor pipe 31 serves as a container in which superheated steam is generated. For the second conductor pipe 31, austenitic stainless steel, such as SUS 304, or an alloy, such as Inconel, having high heat resistance and mechanical strength may be used. Mutually adjacent wound portions of the second conductor pipe 31 are electrically connected to each other by welding, for example.

The second inlet port P3 is connected to an external pipe via which the steam from the saturated steam generation unit 2 is fed to the second conductor pipe 31, or to the first outlet port P2 of the first conductor pipe 21 included in the saturated steam generation unit 2. That is, the first winding portion 21a of the first conductor pipe 21 and the second winding portion 31a of the second conductor pipe 31 are connected to each other by a communication pipe part CP including at least the first lead-out portion 21c and the second lead-in portion 31b. When an external pipe is used, the external pipe also serves as a part of the communication pipe part CP. Furthermore, the second outlet port P4 is connected to an external pipe for supplying the generated superheated steam to a side where the superheated steam is used (e.g., a heat treatment chamber).

The magnetic flux generation mechanism 32 includes an iron core 32a and an induction coil 32b wound about the iron core 32a. An AC power supply is connected to the induction coil 32b, and controlled power is supplied thereto. The frequency of the AC power supply is 50 Hz or 60 Hz that is a commercial frequency. The electric power supplied from the AC power supply causes the induction coil 32b to serve as a primary coil, and, as a result of the second conductor pipe 31 receiving the supply of power from the primary coil, induction current flows through the second conductor pipe 31, and causes the second conductor pipe 31 to serve as a single-turn secondary coil. The second conductor pipe 31 generates Joule heat, by which the steam flowing inside the conductor pipe 31 is heated.

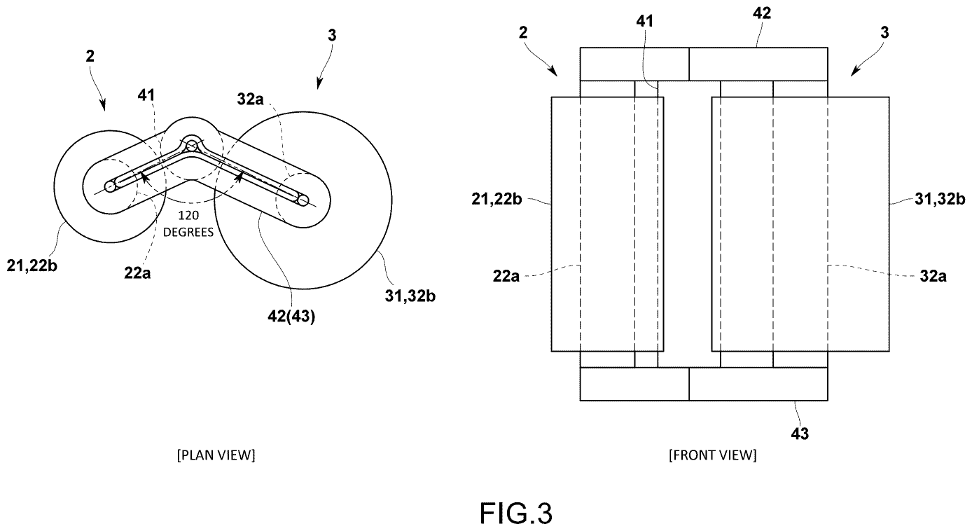

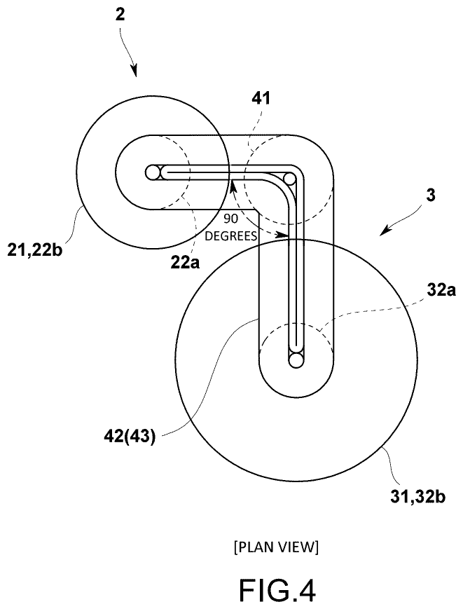

As illustrated in FIGS. 3 and 4, the superheated steam generator 100 according to the embodiment is provided with, in addition to the iron core 22a of the saturated steam generation unit 2 and the iron core 32a of the superheated steam generation unit 3, a common iron core 41 serving as a common path of the magnetic fluxes generated in the two respective iron cores 22a, 32a. An upper part and a lower part of the common iron core 41 are then connected to upper parts and lower parts of the two respective iron cores 22a, 32a, with respective yoke cores 42, 43, to form a single three-legged iron core. With this configuration, the size of the entire iron core can be reduced, so that the entire device can be reduced in size. In other words, in the superheated steam generator 100 according to this embodiment, the saturated steam generation unit 2 and the superheated steam generation unit 3 are formed as a single three-legged iron core.

In FIGS. 3 and 4, the iron cores 22a, 32a, 41 are positioned at the respective vertices of a triangle in a plan view, and the yoke cores 42, 43 are provided in a manner forming a bent shape, with the bent point at the common iron core 41 in a plan view. In this manner, the distance between the two iron cores 22a, 32a can be reduced, so that the size of the entire three-legged iron core in the width direction can be reduced, and that the space saving can be achieved.

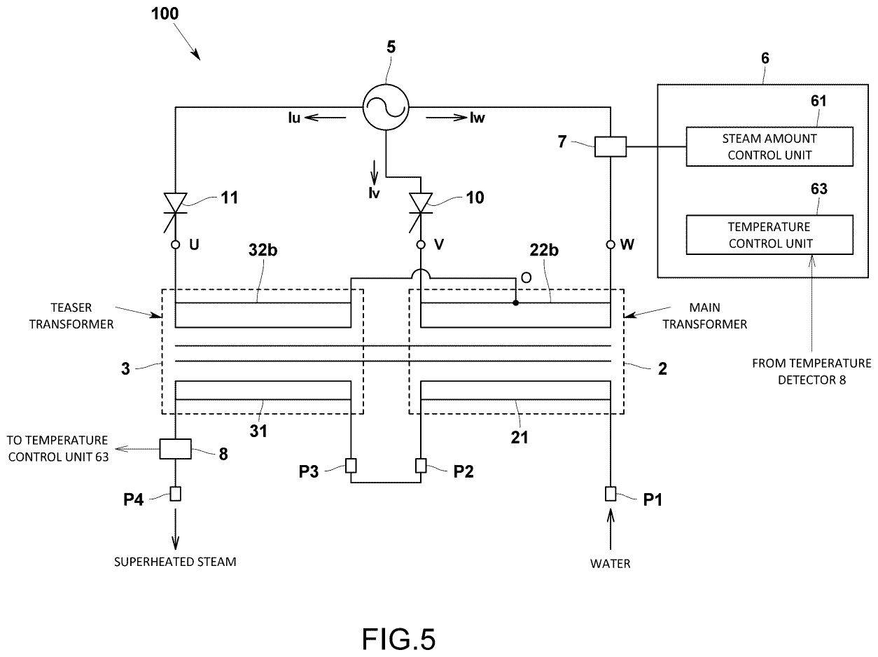

Furthermore, in this embodiment, the induction coil 22b of the saturated steam generation unit 2 and the induction coil 32b of the superheated steam generation unit 3 are connected in a Scott connection for converting the three-phase alternating current of a three-phase alternating current power supply 5 into two single-phase alternating currents (see FIG. 5). In other words, the superheated steam generator 100 according to the embodiment has a configuration including a Scott connection transformer having a single three-legged iron core. A Scott connection transformer includes a main transformer and a teaser transformer. The part corresponding to the saturated steam generation unit 2 serves as the main transformer, and the part corresponding to the superheated steam generation unit 3 serves as the teaser transformer.

As illustrated in FIG. 5, a first controller 10 for controlling voltage or current is provided to one of two input-side phases of the main transformer. In FIG. 5, a semiconductor control element such as a thyristor is provided to the V phase that is on the input side of the main transformer, as the first controller 10. In addition, a second controller 11 for controlling voltage or current is provided to one-end side of the primary coil (the induction coil 32b) that is on the input side of the teaser transformer (to the U-phase side or the side of the midpoint O of the primary teaser coil). In the same manner as the first controller 10, a semiconductor control element such as a thyristor is used as the second controller 11. The control device 6 is configured to control the first controller 10 and the second controller 11 so as to control the voltage applied to the primary coil (induction coil 22b) of the main transformer and the voltage applied to the primary coil (induction coil 32b) of the teaser transformer, individually. The control device 6 is a computer including a CPU, a memory, and an input/output interface.

### <Control of Superheated Steam Generator 100>

The control device 6 controls the amount of saturated steam in the saturated steam generation unit 2 as follows.

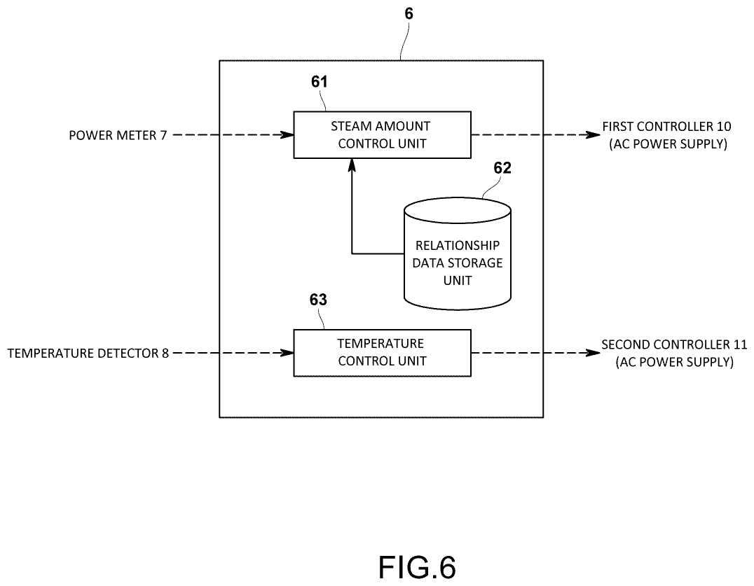

As illustrated in FIG. 6, the control device 6 includes a steam amount control unit 61 that controls the amount of saturated steam generated by the saturated steam generation unit 2, on the basis of the amount of electric power to be supplied to the saturated steam generation unit 2. The control device 6 further includes a relationship data storage unit 62 that stores relationship data indicating a relationship between the amount of steam generated by the saturated steam generation unit 2 and the amount of electric power supplied to the saturated steam generation unit 2.

The relationship data stored in the relationship data storage unit 62 is obtained by actually measuring the amount of steam generated by the saturated steam generation unit 2, and the amount of electric power supplied to the saturated steam generation unit 2. Note that this relationship data is data actually measured while the first outlet port P2 of the first conductor pipe 21 in the saturated steam generation unit 2 is opened to the atmospheric pressure (under the atmospheric pressure condition).

The steam amount control unit 61 also acquires electric power data from the power meter 7 that measures the amount of electric power to be supplied to the saturated steam generation unit 2, and controls the first controller 10 so as to bring the amount of steam to a predetermined amount of steam, using the relationship data. Specifically, the steam amount control unit 61 controls the first controller 10 so as to bring the amount of electric power measured by the power meter 7 to a target amount of electric power, the target amount being calculated from the relationship data and the predetermined amount of steam. The power meter 7 is provided to one of two input-side phases of the main transformer included in the saturated steam generation unit 2. In other words, in this embodiment, the amount of saturated steam is controlled only on the basis of the amount of electric power measured by the power meter 7.

In the superheated steam generator 100 that controls the amount of steam, the saturated steam generation unit 2 and the superheated steam generation unit 3 are caused to operate under the atmospheric pressure condition. No pressure-reduction valve, regulation valve for adjusting the amount of steam, electric proportional valve, and the like are provided between the saturated steam generation unit 2 and the superheated steam generation unit 3, specifically, to the communication pipe part CP.

During the period from startup to the steam amount control, the control device 6 controls the first controller 10 to set the electric power supplied to the saturated steam generation unit 2 to the maximum level or a level lower than or equal to the level at which each unit does not fail. This control is continued to the point immediately before the water in the saturated steam generation unit 2 reaches 100° C., e.g., until the water temperature reaches 95° C., and then the control is shifted to the steam amount control described above.

The control device 6 also controls the temperature of the superheated steam generated by the superheated steam generation unit 3 as follows.

In the superheated steam generator 100 according to this embodiment, the temperature detector 8 detects the temperature of the superheated steam leaving the second conductor pipe 31 of the superheated steam generation unit 3, or the pipe temperature at the second outlet port P4 of the second conductor pipe 31.

The control device 6 includes a temperature control unit 63 that inputs a control signal corresponding to a deviation of the detected temperature obtained by the temperature detector 8 with respect to a target superheated steam temperature, to the second controller 11 to control the AC voltage applied to the induction coil 32b. The temperature control unit 63 feedback-controls the temperature to which the superheated steam is heated by the second conductor pipe 31 so that a deviation with respect to the target temperature falls within ±1° C.

Also provided in the embodiment is a safety device 12 that prevents damage to the saturated steam generation unit 2, on the basis of the pressure or the temperature of the steam generated by the steam generation unit 2.

The safety device 12 illustrated in FIG. 1 includes a steam releasing unit 12a that is provided to the saturated steam generation unit 2 or between the steam generation unit 2 and the superheated steam generation unit 3, and that releases the steam generated by the saturated steam generation unit 2 to the outside.

The releasing unit 12a is a safety valve that releases the steam to the outside when the pressure reaches a set pressure. Specifically, the safety valve 12a releases the steam inside the first conductor pipe 21 to the outside at the set pressure that is a steam pressure lower than 1 MPa (179.88° C. in terms of temperature). The superheated steam generator 100 according to the embodiment corresponds to a small-sized once-through boiler or a simple once-through boiler according to the stipulation in the Ordinance on Safety of Boilers and Pressure Vessels, and the safety valve 12a releases the steam inside the first conductor pipe 21 to the outside when the steam pressure reaches 0.4 MPa (specifically, 0.4758 MPa (150° C. in terms of temperature)), for example. The safety valve 12a is provided to the first winding portion 21a of the first conductor pipe 21, or to the communication pipe part CP communicably connecting the first winding portion 21a of the first conductor pipe 21 and the second winding portion 31a of the second conductor pipe 31. In this embodiment, the safety valve 12a is provided to the first lead-out portion 21c of the communication pipe part CP. The safety valve 12a may be provided to an upper part of the first winding portion 21a. The safety valve 12a may also be provided to the second lead-in portion 31b of the second conductor pipe 31.

With the superheated steam generator 100 configured as described above, because the electric power required to obtain an intended amount of steam is supplied, a stable amount of steam can be generated, and as a result, the amount of the superheated steam output at a predetermined temperature can be stabilized within an error range of ±1%. Even if the discharge pressure increases as a result of an increase in the load loss of the steam channel, the safety valve 12a releases the steam inside the first conductor pipe 21 to the outside, when the discharge pressure reaches a predetermined pressure. Therefore, it is possible to prevent damage to the superheated steam generator including the steam generation unit 2.

Steam heating is not only capable of heating a load having a complex shape relatively uniformly because steam goes around such a load, but also is safe means for heating, in terms of explosion resistance and ignitability, because oxygen is extremely low. Furthermore, because the amount of energy supplied by the steam is basically proportional to the product of the steam temperature and the amount of steam, conventional boilers have controlled the amount of steam by controlling the pressure of the steam using a pressure-reduction valve or the like, and by adjusting the area of the steam channel using a proportional valve or the like. It has been considered that steam heating cannot be applied to microfabrication, because valves with such mechanical structures are not quite capable of making such fine control, and of ensuring reproducibility. The power control system according to the embodiment, however, solves such a problem, and makes the steam heating available as uniform and highly accurate means for heating.

### Second Embodiment

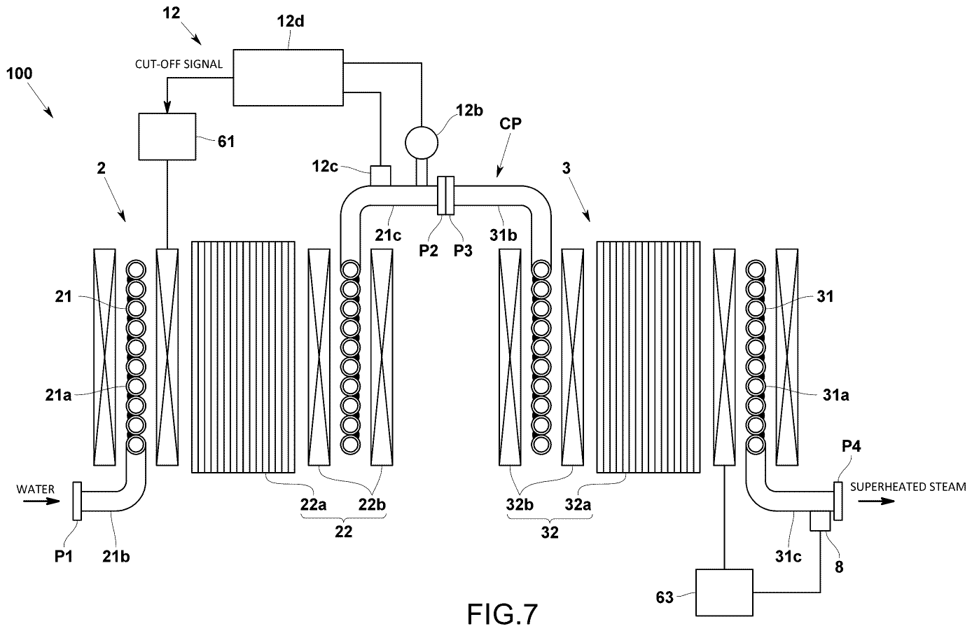

A superheated steam generator 100 according to a second embodiment will now be explained with reference to FIG. 7. In the superheated steam generator 100 according to the second embodiment, the configurations of the saturated steam generation unit 2 and the superheated steam generation unit 3 are the same as those in the first embodiment, but the configuration of the safety device 12 is different.

Specifically, as illustrated in FIG. 7, the safety device 12 includes a pressure sensor 12b that detects the pressure of the steam generated by the saturated steam generation unit 2, a temperature sensor 12c that detects the temperature of the steam generated by the saturated steam generation unit 2, and a safety circuit 12d that outputs an alert signal for cutting off or limiting the electric power supply to the saturated steam generation unit 2, on the basis of the detected pressure from the pressure sensor 12b and the detected temperature from the temperature sensor 12c. The pressure sensor 12b and the temperature sensor 12c are provided to the steam generation unit 2, or between the steam generation unit 2 and the superheated steam generation unit 3. Specifically, the pressure sensor 12b and the temperature sensor 12c are provided to the first winding portion 21a of the first conductor pipe 21 or to the communication pipe part CP communicably connecting the first winding portion 21a of the first conductor pipe 21 and the second winding portion 31a of the second conductor pipe 31. The steam amount control unit 61 then cuts off or limits the electric power supply to the saturated steam generation unit 2, in response to the alert signal output from the safety circuit 12d. The safety circuit 12d may be also configured to issue an alert signal to a user, on the basis of the detected pressure from the pressure sensor 12b and the detected temperature from the temperature sensor 12c.

The safety circuit 12d compares the detected pressure from the pressure sensor 12b with a threshold pressure lower than 1 MPa (e.g., 0.35 MPa), and outputs the alert signal when the detected pressure becomes higher than or equal to the threshold pressure. The safety circuit 12d also compares the detected temperature from the temperature sensor 12c with a threshold temperature lower than 179.88° C., and outputs the alert signal when the detected temperature becomes higher than or equal to the threshold temperature.

As described above, in the safety circuit 12d, the threshold temperature (alert temperature) or the threshold pressure (alert pressure) is set based on the target range of variation (for example, ±1%) in the amount of generated steam. As a result, measures for reducing the pressure loss value in the steam channel can be taken on the user side. In the power control system, the stability of the amount of generated steam can be numerically made clear, so that usability for users is improved.

Specifically, the safety circuit 12d may be configured to compare the detected pressure from the pressure sensor 12b with the boundary-point pressure at which the target range of variation in the amount of generated steam is exceeded, and output the alert signal when the detected pressure reaches the boundary-point pressure. When the alert signal is output from the safety circuit 12d, the steam amount control unit 61 may cut off or limit the electric power supply to the saturated steam generation unit 2. Because power-controlled superheated steam generators are not provided with a pressure-reduction valve, a regulation valve for adjusting the amount of steam, and an electric proportional valve, the steam pressure is kept low, so that the saturated steam pressure of 0.1 MPa, the saturated steam temperature of 99.63° C., and the enthalpy of 2675 KJ/kg can be considered as the minimum values. For example, assuming that the target range of variation in the amount of generated steam is set as ±1.5%, the enthalpy is calculated as 2675×1.03=2755 KJ/kg. The saturated steam pressure corresponding to this enthalpy is then 0.6 MPa, and the saturated steam temperature corresponding thereto is 158.84° C. In such a case, the boundary-point pressure is set to 0.6 MPa, as an example. The boundary-point pressure is set to a pressure lower than the pressure setting of the releasing unit 12a.

The safety circuit 12d may also be configured to output a caution signal when the detected pressure from the pressure sensor 12b exceeds the predetermined threshold pressure (caution pressure, e.g. 0.30 MPa) that is lower than a boundary-point pressure (e.g., 0.6 MPa) or a threshold pressure (alert pressure, e.g., 0.35 MPa). The caution pressure is set to a pressure of such a level not causing damage to a user-side facility where the superheated steam generator 100 is incorporated. By outputting the caution signal on the basis of the caution pressure in the manner described above, it is possible to encourage the user to inspect the user-side facility in which the superheated steam generator 100 is incorporated.

The safety circuit 12d may also be configured to compare the detected temperature from the temperature sensor 12c with the boundary-point temperature at which a target range of variation in the amount of generated steam is exceeded, and output an alert signal when the detected temperature reaches the boundary-point temperature. When the alert signal is output from the safety circuit 12d, the steam amount control unit 61 may cut off or limit the electric power supply to the saturated steam generation unit 2. When the target range of variation in the amount of generated steam is set to ±1.5% as described above, the boundary-point temperature is set to 158.84° C., for example. The boundary-point temperature is set to a temperature where the corresponding saturated steam pressure becomes lower than the set pressure of the releasing unit 12a.

The safety circuit 12d may also be configured to output a caution signal when the detected temperature from the temperature sensor 12c exceeds a predetermined threshold temperature (caution temperature) that is lower than the boundary-point temperature (e.g., 158.84° C.) or the threshold temperature (alert temperature). The caution temperature is set to a temperature of such a degree not causing damage to the user-side facility where the superheated steam generator 100 is incorporated. By outputting the caution signal on the basis of the caution temperature in the manner described above, it is possible to encourage the user to inspect the user-side facility in which the superheated steam generator 100 is incorporated.

As the thermal energy required in the steam generation unit 2, there is a separate thermal energy for bringing the water temperature to 99.63° C., but this is a value unique to each model, so that there will be no large variation, as long as the range of incoming water temperature is controlled. Furthermore, heat dissipation from elements such as the pipes also affects the temperature, but because the temperature of the generated steam is relatively low, e.g., 100 to 180° C., and also because thermal insulation is provided, such heat dissipation is small, as compared with the latent heat of vaporization, and therefore has an only slight effect. By taking this heat dissipation into consideration in the calculation of the variation using actual measurements, the boundary-point pressure or the boundary-point temperature can be calculated accurately.

The safety device 12 may also have a configuration including the releasing unit 12a according to the first embodiment, in addition to the configuration illustrated in FIG. 7.

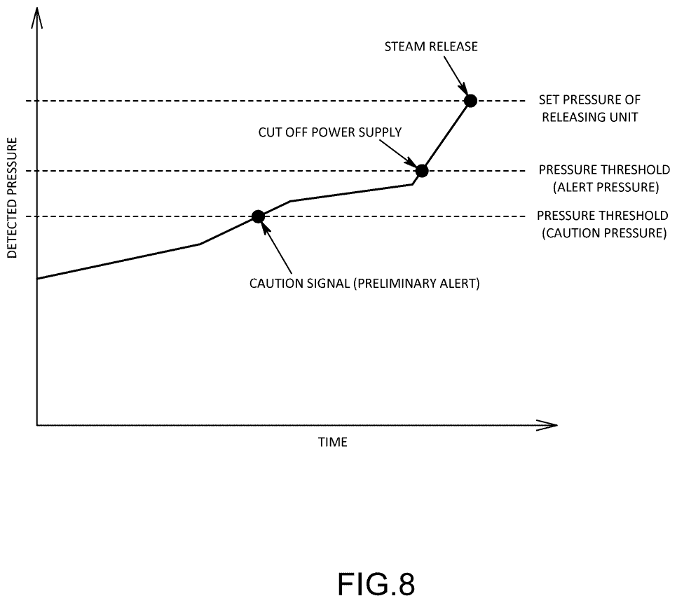

By including the releasing unit 12a in the configuration of the safety device 12, in addition to the safety circuit 12d, as illustrated in FIG. 8, for example, the superheated steam generator 100 is configured to execute a staged operation of outputting the caution signal (preliminary alert) on the basis of the caution pressure (caution temperature), as a first stage, cutting off or limiting the electric power supply to the saturated steam generation unit 2, on the basis of the alert pressure (alert temperature), as a second stage, and causing the releasing unit 12a to release the steam to the outside, as a third stage.

The safety device 12 may also be configured not to include the temperature sensor 12c that is included in the configuration in FIG. 7. In such a case, the safety circuit 12d outputs the alert signal for cutting off or limiting the electric power supply to the saturated steam generation unit 2 on the basis of the detected pressure from the pressure sensor 12b.

In addition, the safety device 12 may be configured not to include the pressure sensor 12b that is included in the configuration in FIG. 7. In such a case, the safety circuit 12d outputs the alert signal for cutting off or limiting the electric power supply to the saturated steam generation unit 2 on the basis of the detected temperature from the temperature sensor 12c.

### <Other Modifications>

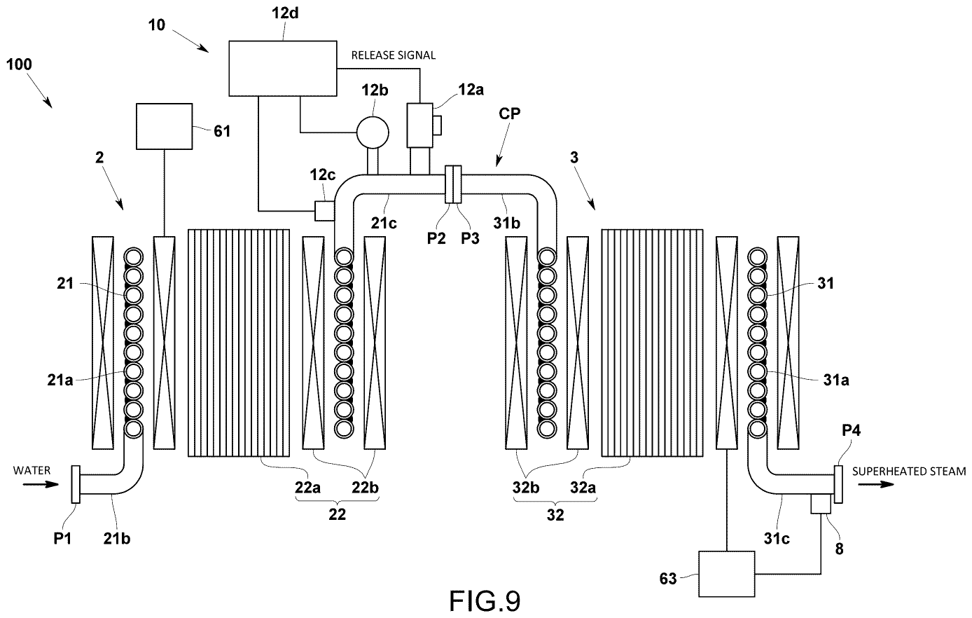

As an alternative to the safety valve that opens when a set pressure setting is reached, the steam releasing unit 12a in the safety device 12 may be a configuration for releasing the steam to the outside in response to a release signal from the outside. For such a configuration, the safety circuit 12d may be configured to output the release signal to the steam releasing unit 12a on the basis of a detected pressure from the pressure sensor 12b or a detected temperature from the temperature sensor 12c, as illustrated in FIG. 9.

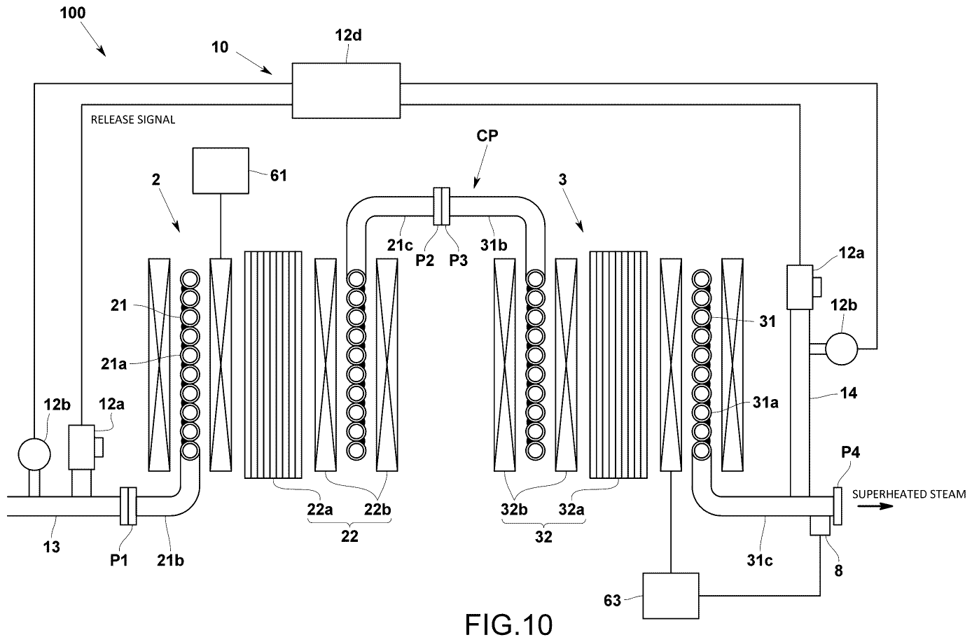

The safety device 12 may also be provided to the second winding portion 31a or the second lead-out portion 31c of the superheated steam generation unit 3, or to the steam generation unit 2 or a water supply pipe 13 that supplies water to the steam generation unit 2, as illustrated in FIG. 10. These configurations may be added to a configuration in which the safety device 12 is provided to the first winding portion 21a or the communication pipe part CP, as described above.

When the safety device 12 is provided to the superheated steam generation unit 3, as illustrated in FIG. 10, the releasing unit 12a or the pressure sensor 12b described above may be provided to the second outlet port P4 of the second lead-out portion 31c in the second conductor pipe 31, or to the vicinity thereof (e.g., a straight part of the second lead-out portion 31c), with a measurement pipe 14 disposed therebetween. It is also possible to provide the temperature sensor 12c described above to the second outlet port P4 of the second lead-out portion 31c in the second conductor pipe 31, or to the vicinity thereof (e.g., a straight part of the second lead-out portion 31c). The safety operations of the relevant units using the releasing unit 12a, the pressure sensor 12b, or the temperature sensor 12c have been described above. In the safety operation using the temperature sensor 12c, because the superheated steam generation unit 3 is controlled on the basis of the temperature, the activation thereof is determined by the set temperature. For example, when the set temperature of the superheated steam is 150° C., the temperature control unit 63 may make a zero control input as a result of a temperature increase that is caused by an increase in the load loss in the steam channel. The safety operation using the temperature sensor 12c is then activated when the temperature of the superheated steam rises gradually.

When the safety device 12 is provided to the first lead-in portion 21b of the steam generation unit 2 or to the water supply pipe 13, as illustrated in FIG. 10, the releasing unit 12a or the pressure sensor 12b described above may be provided to the first inlet port P1 on the first lead-in portion 21b of the steam generation unit 2, to the vicinity thereof (e.g., a straight part of the first lead-in portion 21b), or to the water supply pipe 13. The safety operations of the relevant units using the releasing unit 12a or the pressure sensor 12b are as described above.

Furthermore, the position where the releasing unit 12a in the safety device 12 is provided and the position where the pressure sensor 12b or the temperature sensor 12c is provided may be different from each other. For example, the pressure sensor 12b or the temperature sensor 12c may be provided to the steam generation unit 2, or between the steam generation unit 2 and the superheated steam generation unit 3, and the releasing unit 12a may be provided to the steam generation unit 2 or the water supply pipe 13 so as to release the water. The pressure sensor 12b or the temperature sensor 12c may also be provided to the superheated steam generation unit 3, and the releasing unit 12a may be provided to the steam generation unit 2 or to the water supply pipe 13 so as to release the water. The pressure sensor 12b may also be provided to the water supply pipe 13, and the releasing unit 12a may be provided to the steam generation unit 2, or between the steam generation unit 2 and the superheated steam generation unit 3, so as to release the steam.

The communication pipe part CP according to the embodiment described above may include a third inlet port for feeding steam, superheated steam, or another gas other than the steam from the outside, or a third lead-in portion having the third inlet port. Through such a third inlet port, the steam generated by an external boiler, superheated steam recycled after being guided into the heat treatment chamber, nitrogen gas, or the like is introduced. In such a case, by providing the safety device 12 to the third lead-in portion, the safety device 12 is provided to the communication pipe part CP.

The saturated steam generation unit 2 and the superheated steam generation unit 3 may be of electric-heating steam generation unit, without limitation to induction-heating steam generation unit. In this case, an AC power supply or a DC power supply is connected to both ends of the conductor pipes 21, 31 through which fluid flows, so that the AC current or the DC current passes through the conductor pipes 21, 31, and that the conductor pipes 21, 31 generate Joule heat. In this case, each of the conductor pipes 21, 31 may have a various shape, such as a shape having a plurality of straight portions and a plurality of bent portions each communicably connecting two of the straight portions, without limitation to the spiral shape.

Furthermore, it should be needless to say that the present invention is not limited to the embodiment described above, and various modifications are still possible within the scope not departing from the gist of the present invention.

REFERENCE CHARACTER LIST

| | |
|---|---|
| 100 | superheated steam generator |
| 2 | saturated steam generation unit (steam generation unit) |
| 3 | superheated steam generation unit |
| 61 | steam amount control unit (control unit) |
| 12 | safety device |
| 12a | releasing unit |
| 12b | pressure sensor |
| 12c | temperature sensor |
| 12d | safety circuit |

What is claimed is:

1. A superheated steam generator comprising:
a steam generation unit that generates steam from water by inductively heating a first conductor pipe having a spiral shape;
a superheated steam generation unit that generates superheated steam from the steam by inductively heating a second conductor pipe having a spiral shape;
a control unit that controls an amount of steam to be generated by the steam generation unit based on an amount of electric power to be supplied to the steam generation unit; and
a safety device that prevents damage to the steam generation unit or the superheated steam generation unit, based on a pressure or a temperature of the steam in the steam generation unit, wherein
the first conductor pipe has a first winding portion that is a spiral winding,
the second conductor pipe has a second winding portion that is a spiral winding,
and the safety device is provided to the first winding portion, or to a communication pipe part communicably connecting the first winding portion and the second winding portion.

2. The superheated steam generator according to claim 1, wherein
the first conductor pipe includes a first lead-out portion having a first outlet port through which the steam is guided out,
the second conductor pipe includes a second lead-in portion having a second inlet port through which the steam is introduced, and
the communication pipe part includes at least the first lead-out portion and the second lead-in portion.

3. The superheated steam generator according to claim 1, wherein the safety device includes a releasing unit that is provided to the first winding portion or to the communication pipe part communicably connecting the first winding portion and the second winding portion, and that releases the steam to outside.

4. The superheated steam generator according to claim 1, wherein
the safety device includes:
a pressure sensor that is provided to the first winding portion or the communication pipe part communicably connecting the first winding portion and the second winding portion, and that detects a pressure of the steam; and
a safety circuit that outputs an alert signal based on a detected pressure from the pressure sensor.

5. The superheated steam generator according to claim 1, wherein
the safety device includes:
a temperature sensor that is provided to the first winding portion or to the communication pipe part communicably connecting the first winding portion and the second winding portion, and that detects a temperature of the steam; and
a safety circuit that outputs an alert signal based on a detected temperature from the temperature sensor.

6. The superheated steam generator according to claim 1, wherein
the safety device includes:
a pressure sensor that is provided to the first winding portion or to the communication pipe part communicably connecting the first winding portion and the second winding portion, and that detects a pressure of the steam;
a temperature sensor that is provided to the first winding portion or to the communication pipe part communicably connecting the first winding portion and the second winding portion, and that detects a temperature of the steam; and
a safety circuit that outputs an alert signal based on a detected pressure from the pressure sensor and a detected temperature from the temperature sensor.

7. The superheated steam generator according to claim 4, wherein the safety circuit outputs a caution signal before outputting the alert signal.

8. The superheated steam generator according to claim 1, wherein the safety device is further provided to the second winding portion or to the second lead-out portion having a second outlet port through which the superheated steam is guided out, and prevents damage to the steam generation unit or the superheated steam generation unit based on a pressure or a temperature of the superheated steam.
